(19) United States
(12) Patent Application Publication
(10) Pub. No.: US 2019/0072711 A1
(43) Pub. Date: Mar. 7, 2019

(54) ILLUMINATION APPARATUS, LINE SENSOR ASSEMBLY, READING APPARATUS, AND PRINTING APPARATUS

(71) Applicant: CANON COMPONENTS, INC., Saitama-ken (JP)

(72) Inventors: Ryoki MATSUI, Saitama-ken (JP); Hidemasa YOSIDA, Saitama-ken (JP); Suguru TASHIRO, Saitama-ken (JP)

(21) Appl. No.: 16/123,199

(22) Filed: Sep. 6, 2018

(30) Foreign Application Priority Data
Sep. 7, 2017 (JP) 2017-172405
Aug. 30, 2018 (JP) 2018-162074

(51) Int. Cl. F21V 8/00; H04N 1/028

(52) U.S. Cl. CPC G02B 6/0096; H04N 1/02845

(57) ABSTRACT

There is provided with an illumination apparatus. The illumination apparatus includes a light source. A rod-shaped light guide includes, as a first surface, a light emitting surface that emits light taken from the light source. A light guide cover is configured to cover a second surface different from the first surface among surfaces of the light guide. The second surface is a surface extending in a longitudinal direction of the light guide. The light guide cover is extended in the longitudinal direction. The light guide cover includes at least one finger holding the light guide.

### BACKGROUND OF THE INVENTION

### Field of the Invention

The present invention relates to an illumination apparatus, a line sensor assembly, a reading apparatus, and a printing apparatus.

### Description of the Related Art

As an illumination apparatus for a reading apparatus that uses a line sensor, there is known an apparatus that irradiates a linear irradiation region with light from a point light source using a rod-shaped light guide. For example, according to Japanese Patent Laid-Open No. 2014-033440, light sources are respectively arranged at two ends of a rod-shaped light guide, light beams entering the light guide from the two end faces of the light guide in a longitudinal direction exit from the side surface of the light guide extending in the longitudinal direction, and a reading target is irradiated with the light beams. The light guide includes a light diffusing surface that extends in the longitudinal direction and diffuses light, and an emitting surface that extends in the longitudinal direction and emits light toward the reading target. Furthermore, a light guide cover is attached to the light guide to improve the use efficiency of light. The light guide cover covers the light diffusing surface of the light guide, and reflects light externally emitted from the light diffusing surface to enter the light guide.

### SUMMARY OF THE INVENTION

According to an embodiment of the present invention, an illumination apparatus comprises: a light source; a rod-shaped light guide including, as a first surface, a light emitting surface that emits light taken from the light source; and a light guide cover configured to cover a second surface different from the first surface among surfaces of the light guide, wherein the second surface is a surface extending in a longitudinal direction of the light guide, wherein the light guide cover is extended in the longitudinal direction, and wherein the light guide cover includes at least one finger holding the light guide.

Further features of the present invention will become apparent from the following description of exemplary embodiments (with reference to the attached drawings).

### BRIEF DESCRIPTION OF THE DRAWINGS

FIG. 1 is an exploded perspective view showing the arrangement of an illumination apparatus according to one embodiment;

FIG. 2 is a view showing the arrangement of one end portion of a light guide in a longitudinal direction;

FIG. 3A is a sectional view of the light guide and a light guide cover in a holding portion;

FIG. 3B shows a reference example of a sectional view of the light guide and the light guide cover in the holding portion;

FIG. 4A is a view for explaining the attachment direction of the light guide cover;

FIG. 4B is a view for explaining the attachment direction of the light guide cover in the reference example;

FIG. 5 is a schematic view showing the arrangement of a line sensor assembly according to one embodiment; and

FIG. 6 is a schematic view showing the arrangement of a printing apparatus according to one embodiment.

### DESCRIPTION OF THE EMBODIMENTS

In the arrangement described in Japanese Patent Laid-Open No. 2014-033440, to assemble a light guide and a light guide cover, it is necessary to insert the light guide into the light guide cover along the longitudinal direction. This poses a problem that assembly is not easy.

An embodiment of the present invention facilitates assembly of an illumination apparatus.

Some embodiments of the present invention will be described below with reference to the accompanying drawings. However, the scope of the present invention is not limited to the following embodiments. An illumination apparatus according to one embodiment of the present invention can be used in a line sensor assembly. First, a line sensor assembly according to one embodiment of the present invention that includes the illumination apparatus according to one embodiment of the present invention, a lens array, a line sensor, and a housing will be explained briefly.

FIG. 5 is a perspective view schematically showing the overall structure of a line sensor assembly 6 according to an embodiment. For the sake of easy understanding of the structure, FIG. 5 shows X, Y, and Z directions orthogonal to each other. The line sensor assembly 6 has an elongated structure extended in the X direction. In this specification, the X direction will sometimes be referred to as an elongation direction hereinafter. The Z direction corresponds to the height direction of the line sensor assembly 6. The line sensor assembly 6 can read a reading target image located in the +Z direction with respect to the line sensor assembly 6. The Y direction corresponds to the width direction of the line sensor assembly 6. Although the reading target is not particularly limited, an example is a printing medium on which a character or an image is formed on a plane, such as an original or a magazine.

As shown in FIG. 5, the line sensor assembly 6 includes an illumination apparatus 1, a lens array 2, a line sensor 3, and a housing 4. The illumination apparatus 1 has a shape extending in the X direction, and can irradiate an irradiation region extending in the X direction on the reading target with light at once. The illumination apparatus 1 emits, from each position of the illumination apparatus 1 in the X direction toward the reading target via a light guide, light from a light source 5 located in each end portion. In one embodiment, the light includes a visible light wavelength. Instead of visible light, the light may include X-rays, ultraviolet rays, or infrared rays. In another embodiment, the light may include one, two or more, or all of X-rays, ultraviolet rays, and infrared rays.

The lens array 2 condenses light emitted from the illumination apparatus 1 toward the reading target, and guides, to the line sensor 3, the light including information of the reading target. The lens array 2 has a shape extending in the X direction, and can condense light from the irradiation region extending in the X direction on the reading target at once. The lens array 2 is, for example, a rod lens array having a structure in which rod lenses each extending in the Z direction are arrayed in the X direction. In the example shown in FIG. 5, the lens array 2 is separated from the illumination apparatus 1 in the Y direction, and fixed onto the housing 4.

The line sensor 3 detects the light condensed by the lens array 2. The line sensor 3 has a shape extending in the X direction, and can read, at once, the light condensed by the lens array 2. As the line sensor 3, for example, a known photoelectric conversion element such as a CMOS image sensor can be used. In the example shown in FIG. 5, the line sensor 3 is separated from the lens array 2 in the −Z direction, and fixed onto the housing 4.

The housing 4 can support and contain the illumination apparatus 1, the lens array 2, and the line sensor 3. The arrangement of the housing 4 is not particularly limited. As shown in FIG. 5, the housing 4 can have a shape extending in the X direction. In one embodiment, the housing 4 has a black surface or is made of a black material in order to prevent generation of noise caused when light reflected irregularly by the surface reaches the line sensor 3.

The arrangement of the line sensor assembly 6 is not limited to that shown in FIG. 5. For example, the line sensor assembly 6 may include a first housing in which the illumination apparatus 1 is provided and a second housing in which the lens array 2 and the line sensor 3 are provided. In this case, the first and second housings may be arranged to sandwich the reading target. In this arrangement, the line sensor 3 can detect light that is emitted from the illumination apparatus 1, passes through the reading target, and is condensed by the lens array 2.

The line sensor assembly 6 can be used in a reading apparatus 7. The reading apparatus 7 according to one embodiment of the present invention includes the line sensor assembly 6 and an output unit that outputs read data obtained by the line sensor assembly 6. This output unit is, for example, a substrate fixed to the housing 4. This substrate can receive, as read data, a signal from the line sensor 3 in accordance with a light detection result, perform signal processing if necessary, and then externally output the signal. This substrate can supply externally received power to the illumination apparatus 1 or the line sensor 3.

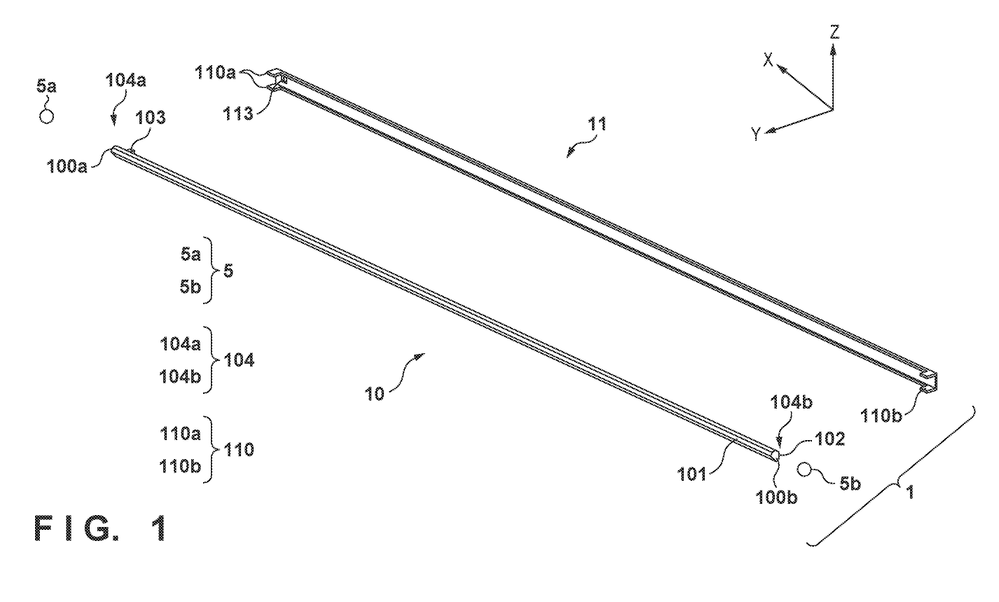

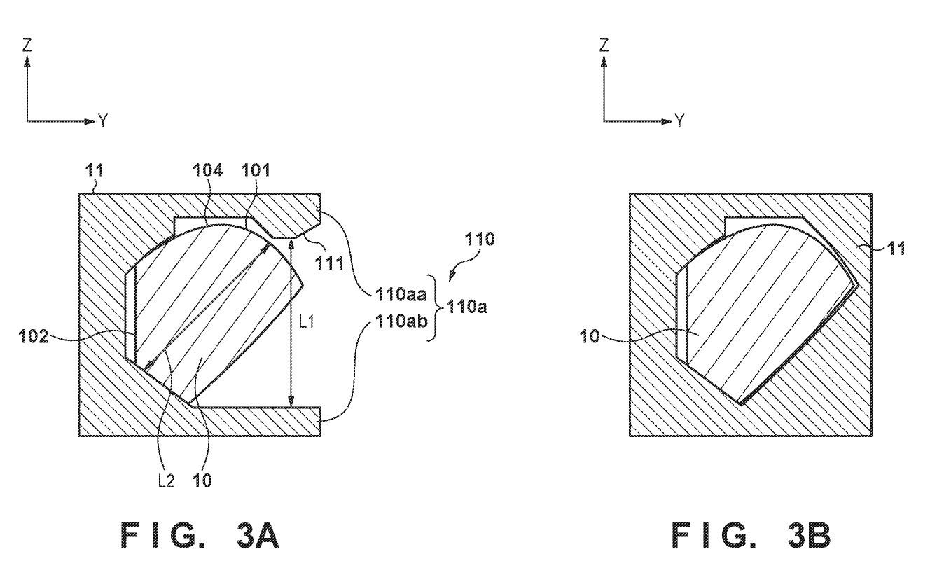

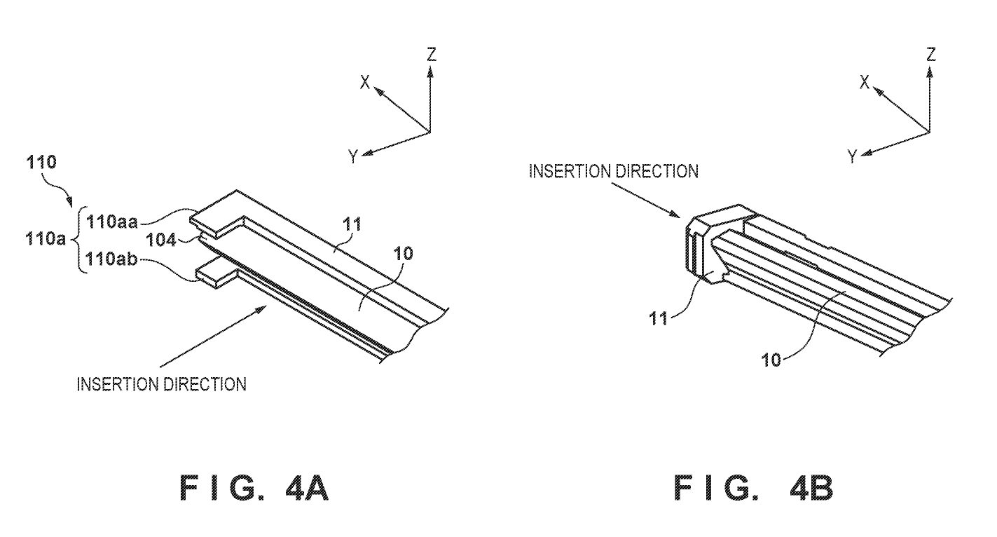

The illumination apparatus according to the present invention will be described in detail below. Note that in the following description, for the sake of easy understanding of the structure, FIGS. 1 to 4B each show the X, Y, and Z directions orthogonal to each other. The X direction in each of FIGS. 1 to 4B corresponds to the longitudinal direction of a light guide 10, and coincides with the X direction in FIG. 5. On the other hand, the Y and Z directions in each of FIGS. 1 to 4B do not necessarily coincide with those in FIG. 5. FIG. 1 is an exploded perspective view showing the arrangement of the illumination apparatus according to one embodiment. The illumination apparatus 1 according to one embodiment of the present invention includes the light guide 10 and a light guide cover 11. The illumination apparatus 1 has a structure in which the light guide 10 and the light guide cover 11 are assembled, as shown in FIGS. 3A and 4A.

As shown in FIG. 1, the light guide 10 is a rod-shaped light guide. The light guide 10 has end faces in the longitudinal direction, which light from the light sources 5 enters. In this embodiment, the light sources 5 include two light sources 5a and 5b, and the light guide 10 includes end faces 100a and 100b in the longitudinal direction, which light beams from the light sources 5a and 5b enter, respectively. Furthermore, the light guide 10 includes, as a first surface 101, a light emitting surface that extends in the longitudinal direction and externally emits the light taken from the light source. The light guide 10 also includes a second surface 102 that extends in the longitudinal direction and is different from the first surface 101. The first surface 101 and the second surface 102 will sometimes be referred to as the emitting surface 101 and the reflecting surface 102, respectively, hereinafter. Note that the rod shape indicates a shape extending in the longitudinal direction. The light guide 10 shown in FIG. 1 extends straight. However, part of the light guide 10, more specifically, one end of the light guide 10 may be bent.

The light guide cover 11 has a shape extending in the longitudinal direction. The light guide cover 11 is extended to cover the reflecting surface 102 of the light guide 10 in the longitudinal direction. Note that the light guide cover 11 need not cover the light guide 10 in the entire longitudinal direction of the light guide 10. In one embodiment, the light guide cover 11 covers the central portion of the light guide 10 in the longitudinal direction. For example, at least one end portion of the light guide 10 may be bent. As a practical example, the light guide 10 may include a central portion extending straight and an end portion extending in a direction different from the axial direction of the central portion. In this case as well, the light guide cover 11 can be provided to cover the central portion of the light guide 10. On the other hand, the light guide cover 11 may be provided to cover, in the entire length direction, the light guide 10 having at least one bent end portion. The light guide cover 11 can be applied even if the traveling direction of the light from the light source 5 to the end portion of the light guide 10 is different from that of the light from the end portion of the light guide 10 to the inside of the light guide.

Light can pass through the inside of the light guide 10. That is, the light beams from the light sources 5a and 5b enter the light guide 10 via the end faces 100a and 100b, respectively. The light is guided in the longitudinal direction while being reflected totally in the light guide 10. The light that has reached the reflecting surface 102 is reflected totally or diffusely. The light guide cover 11 is configured to cause the light to be reflected diffusely by the second surface 102 so that the diffusely reflected light emits from the first surface 101. That is, the light guide cover 11 is white as in this embodiment and thus has a function of causing the light that has reached the reflecting surface 102 to be reflected diffusely, and the reading target is irradiated with some of the diffusely reflected light via the light guide 10 and the emitting surface 101. The emitting surface 101 may have a convex shape so that the emitted light is concentrated in a linear irradiation region on the reading target. Note that a diffusely reflecting portion such as a rough surface portion or white-coated portion that reflects the reached light diffusely may be provided in at least part of the reflecting surface 102. In this case as well, the light guide cover 11 can return, to the light guide 10, the light that has emitted outside the light guide 10 by diffuse reflection. In the example shown in FIG. 1, it can be said that the light guide cover 11 can shield the light that has reached at least part of the reflecting surface 102. In the example shown in FIG. 1, it can be said that the light guide cover 11 covers at least part of the reflecting surface 102 so as to be invisible from the outside.

Light can pass through the inside of the light guide 10. For example, the light guide 10 is a transparent member made of a transparent material such as polyacryl. The light guide cover 11 is opaque. In one embodiment, the light guide cover 11 is white to increase the amount of light traveling toward the emitting surface 101. An example of the material of the light guide cover 11 is a polycarbonate containing titanium oxide. On the other hand, to prevent generation of noise caused when light reflected irregularly by the surface reaches the line sensor 3, the light guide cover 11 may be black.

The illumination apparatus 1 can include one or more light sources 5. The light source 5 may be a component outside the illumination apparatus 1. In the example shown in FIG. 1, the illumination apparatus 1 includes the two light sources 5a and 5b as the light sources 5, and the light guide 10 includes, at two ends, the end faces 100a and 100b which light beams from the light sources 5a and 5b enter, respectively. However, only one light source 5 may be used. That is, the illumination apparatus may include one light source 5, and the light guide 10 may include, at one end, an end face 100 which light from the light source 5 enters.

The light guide cover 11 includes an elongated portion extending in the longitudinal direction and at least one finger that holds the light guide 10. In one embodiment, the light guide cover 11 has a long shape with flexibility such as a white polycarbonate member. The finger of the light guide cover 11 is a portion of the light guide cover 11 that protrudes from the elongated portion of the light guide cover 11.

At least one finger of the light guide cover 11 can hold the light guide 10 by applying a force. For example, at least one finger of the light guide cover 11 can be a flexible piece, and can pinch the light guide 10 by an elastic force of the flexible piece. On the other hand at least one finger of the light guide cover 11 may hold the light guide 10 without applying a force. For example, at least one finger of the light guide cover 11 may have a protruded portion 111 as stated below, and the light guide cover 11 may support the light guide without depending on the elastic force. When the finger pinches or catches the light guide 10 or catches the light guide 10 between the finger and the elongated portion, the finger can hold the light guide 10 even if an external force with a certain strength is applied. On the other hand, by applying a stronger external force, it is possible to attach or separate the light guide 10 to or from the light guide cover 11.

At least one finger of the light guide cover 11 may include two fingers whose respective distal ends are separated from each other. In this case, at least one finger of the two fingers can be the flexible piece and can pinch the light guide 10 by an elastic force of the flexible piece. In this embodiment, for example, employing a shape like two fingers separated from each other enables to pinch or catch the light guide 10. At least one of these at least two fingers can also be the flexible piece, thus the fingers can pinch the end portion of the light guide 10 by the elastic force.

The holding portion 110 including at least one finger of the light guide cover 11 as a component will be described in detail below. The holding portion 110 can hold the light guide 10 even when a certain external force is applied, but when a stronger external force is applied, the light guide 10 come off the light guide cover 11. The light guide cover 11 includes an elongated portion extending in the longitudinal direction and a holding portion 110 that holds the light guide 10. The holding portion 110 holds the light guide 10 at a held position 104 as one position of the light guide 10 in the longitudinal direction. On the other hand, the periphery of the light guide 10, that is, a portion in a circumferential direction centered on the X-axis is not covered with the light guide cover 11.

In this embodiment, at least one finger of the light guide cover 11 holds the end portion of the light guide 10 in the longitudinal direction. That is, the holding portion 110 holds the end portion of the light guide 10. The end portion of the light guide 10 indicates a portion with a length from the end face 100 of the light guide 10, that is, within 10% of the length of the light guide 10 in the elongation direction. In this embodiment, the light guide cover 11 may have two or more fingers that hold the light guide 10 at different positions each other. The light guide cover 11 as shown in FIG. 3A includes two or more holding portions 110a and 110b that respectively hold the light guide 10 at different held positions 104a and 104b.

In this embodiment, at least one finger also covers the first surface 101 in the end portion in the longitudinal direction of the light guide 10. FIG. 3A is a sectional view of a plane perpendicular to the elongation direction of the light guide 10 and the light guide cover 11 at the held position 104 according to one embodiment. As shown in FIG. 3A, it is apparent that part of periphery of the light guide 10 is exposed at the held position 104. That is, the light guide 10 is not completely surrounded by the light guide cover 11 at the held position 104. In the cross section perpendicular to the elongation direction at the held position 104, the light guide cover 11 includes an opening. On the other hand, the holding portions 110a, 110b cover the first surface 101 at the held position 104.

Therefore, the light guide 10 can be inserted, from a direction intersecting the longitudinal direction, into a position where it is held by the holding portion 110. For example, as shown in FIG. 4A, when assembling the light guide 10 and the light guide cover 11, the light guide 10 can be inserted from the direction intersecting the longitudinal direction, as indicated by an arrow. That is, since the light guide cover 11 and the holding portion 110 have flexibility, the holding portion 110 is distorted to allow insertion of the light guide 10. In addition, with the elastic force of the holding portion 110, like the force of a leaf spring, the holding portion 110 can hold, after insertion, the light guide 10 not to be removed. This can facilitate assembly or shorten the assembly time. Furthermore, at the time of assembly, the first surface 101 and the second surface 102 of the light guide 10 contact the holding portion 110 only at the held position 104. Therefore, it is possible to reduce distortion of the light guide 10 caused by a physical impact at the time of assembly.

On the other hand, as shown in FIG. 3B, a state in which the holding portion of the light guide cover 11 covers the side surface of the light guide 10 over one round at the held position is illustrated for reference. Therefore, when assembling the light guide 10 and the light guide cover 11, it is necessary to insert the light guide 10 into the light guide cover 11 in the longitudinal direction, as indicated by an arrow in FIG. 4B. This embodiment is superior to the example shown in FIG. 3B, as described above.

FIG. 3A is a sectional view in a direction perpendicular to the longitudinal direction at the held position 104 according to one embodiment. In FIG. 3A, the light guide cover 11 long in the X direction includes two fingers 110aa and 110ab as protruded portions each of which protrudes, at the end in the elongation direction, from the elongated portion as a main body long in the elongation direction. The two fingers 110aa and 110ab serve as the holding portion 110a in FIG. 3A. In this embodiment, the light guide 10 is exposed between the fingers 110aa and 110ab. The exposed portion is not particularly limited, and can be designed in consideration of easy of insertion of the light guide 10 into the light guide cover 11 or difficulty of a drop after insertion. That is, the exposed portion may or may not be a portion corresponding to the emitting surface 101 of the light guide 10. Referring to FIG. 1, the two holding portions 110a and 110b are located at the two ends of the light guide cover 11 in the X direction. The holding portion 110b may have the arrangement shown in FIG. 3A. At least one of the pair of fingers 110aa and 110ab may include a drop prevention portion for further suppressing separation between the light guide 10 and the light guide cover 11. Referring to FIG. 3A, a drop prevention portion is provided at the distal end of the finger 110aa among the two fingers 110aa and 110ab. The drop prevention portion is, for example, a protruded portion 111 that protrudes from the finger 110aa to suppress a drop of the light guide 10. The protruded portion 111 may have, for example, a knob shape, a claw shape, or a needle shape with a fold. Since the finger 110aa includes the protruded portion 111, the holding portion 110 can hold the light guide 10 in a state in which the light guide 10 is more difficult to be removed. In addition, since the finger 110aa includes the protruded portion 111, the holding portion 110 can hold the light guide 10 in a state in which the light guide 10 is more difficult to be removed even when fingers 110aa, 110ab do not apply the force to light guide 10. Note that both the fingers 110aa and 110ab may have protruded portions. In addition, even when the light guide cover 11 has one finger, the holding portion 110 can hold the light guide 10 in a state in which the light guide 10 is more difficult to be removed by providing the one finger with the protruded portion 111.

In one embodiment, the holding portion 110 has flexibility. An example of the holding portion 110 is a resin material like polycarbonate. Note that the material of the holding portion 110 may be the same as that of the light guide cover 11, and the light guide cover 11 and the holding portion 110 can be formed integrally. In the embodiment, the distance between the pair of fingers 110aa and 110ab of the holding portion 110 is shorter than the width of the light guide 10. The width of the light guide 10 indicates the maximum diameter of the light guide 10 (the longest one of distances between arbitrary two points on the periphery in the cross section perpendicular to the elongation direction at the held position 104).

For example, in the example shown in FIG. 3A, the distance between the pair of fingers 110aa and 110ab when no external force is applied is represented by L0, the width of the light guide 10 is represented by L2, and L0<L2 is satisfied. When inserting the light guide 10 into the light guide cover 11, as shown in FIG. 4A, the distance between the pair of fingers 110aa and 110ab can be increased to L2 or more. On the other hand, after assembling the light guide 10 and the light guide cover 11, the distance between the pair of fingers 110aa and 110ab is represented by L1, and L1<L2 is satisfied. As described above, the distance L1 between the pair of fingers 110aa and 110ab is shorter than the width L2 of the light guide 10, and it is thus possible to suppress a drop of the light guide 10 from the light guide cover 11.

In one embodiment, at the held position 104, the holding portion 110 has a shape complementary to the periphery of the light guide 10. In one embodiment, the holding portion 110 covers the first surface 101 in addition to the second surface 102. With these arrangements, the holding portion 110 can hold the light guide more reliably.

In one embodiment, as shown in FIG. 1, the light guide 10 includes the end faces 100 in the longitudinal direction, which light beams from the light sources 5 enter, and the side portion with the region (emitting surface 101) that externally emits light and the region (reflecting surface 102) that reflects light. The light guide cover 11 is configured to cover the side portion of the light guide 10 in the circumferential direction and not to cover a portion in the circumferential direction. For example, the light guide cover 11 can cover at least part of the side portion without covering the region that externally emits light. The circumferential direction indicates a circumferential direction on the cross section in the YZ plane of the light guide 10. For example, the circumferential direction represents a direction in which the light guide 10 is surrounded along the edge of the light guide 10. That is, the light guide 10 need not have a cylindrical shape and the circumferential direction need not be a radial direction. The cross section of the light guide 10 may have an arbitrary shape such as an elliptic shape or a polygonal shape. The light guide cover 11 includes the drop prevention portion like the holding portion 110. This drop prevention portion can hold the light guide 10 at a drop prevention position (for example, the held position 104) so that at least part of the side portion of the light guide 10 at the drop prevention position is exposed.

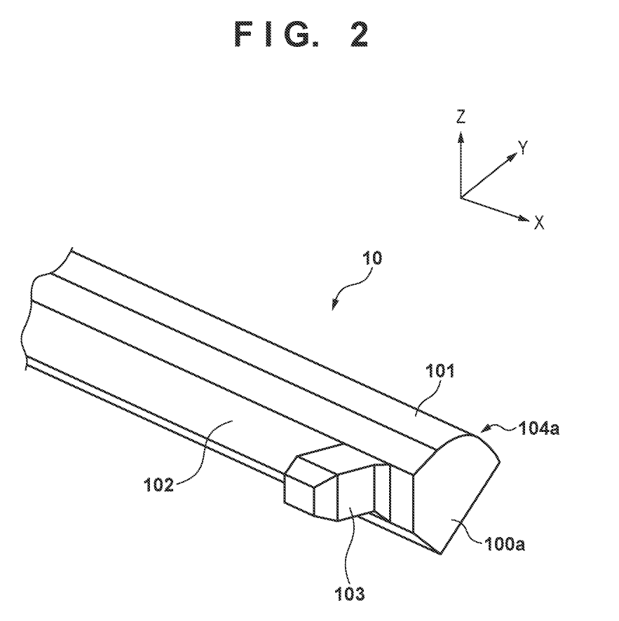

As shown in FIGS. 1 and 2, in one embodiment, the light guide 10 includes a projection 103 on the second surface 102. The projection 103 is engaged with, for example, the housing 4 that contains a sensor substrate, a rod lens array, or the like. The engaged portion of the housing 4 may be a concave portion that receives the projection 103. When the projection 103 is engaged with the housing 4, relative movement of the light guide 10 in the longitudinal direction with respect to the housing 4 is regulated, and it is thus possible to prevent a positional shift of the light guide 10 in the longitudinal direction. The light guide cover 11 includes an opening portion 113 through which the projection 103 extends. For example, the opening portion 113 is a through hole through which the projection 103 can extend. The projection 103 and the opening portion 113 can be formed at positions where, when assembling the light guide 10 and the light guide cover 11 in a correct relative arrangement, the projection 103 extends through the opening portion 113 to protrude to the outer surface of the light guide cover 11. In one embodiment, the light guide 10 includes one or more projections 103. In one embodiment, the projection 103 is formed in the end portion of the light guide 10. With this arrangement, it is easy to assemble the light guide 10 and the housing 4 in a correct relative arrangement.

In another embodiment (not shown), the projection 103 may be engaged with the opening portion 113. In this case, the projection 103 can be engaged with both the housing 4 and the opening portion 113. When the light guide 10, the light guide cover 11, and the housing 4 are assembled in a correct relative arrangement, the projection 103 is engaged with the opening portion 113 in a state in which it extends through the opening portion 113, and also engaged with the engaged portion of the housing 4. In this arrangement, relative movement of the light guide 10 in the longitudinal direction with respect to the light guide cover 11 and the housing 4 is regulated, and it is thus possible to prevent a positional shift of the light guide 10 in the longitudinal direction.

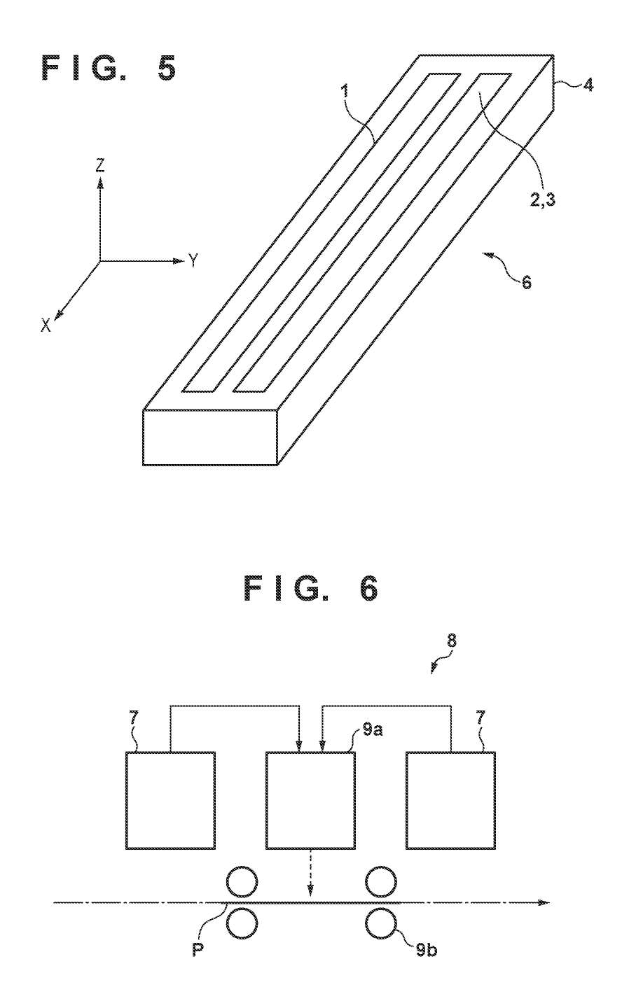

The above-described reading apparatus 7 can be used as a component of a printing apparatus. FIG. 6 is a view showing the schematic arrangement of a printing apparatus 8 according to one embodiment of the present invention. The printing apparatus 8 includes the reading apparatus 7 that reads a medium, a printing unit 9a that executes printing on the medium based on the reading result of the reading apparatus 7, and conveyance units 9b that convey the medium.

The printing unit 9a can print a character, an image, or the like on a medium P (for example, a paper) by an arbitrary method such as an inkjet method or an electrophotographic method. As the conveyance units 9b, conveyance rollers that convey the medium from the upstream side to the downstream side can be used. In one embodiment, the printing apparatus 8 can perform copy processing. In this case, the printing unit 9a prints, on the medium, the image read by the reading apparatus 7. In one embodiment, the printing apparatus 8 can perform feedback control. For example, the reading apparatus 7 can read the medium after printing is executed by the printing unit 9a, and transmit the read data to the printing unit 9a. Based on the read data, the printing unit 9a can confirm the printing state on the medium, and control printing parameters at the time of next printing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2017-172405, filed Sep. 7, 2017, and No. 2018-162074, filed Aug. 30, 2018, which are hereby incorporated by reference herein in their entirety.

What is claimed is:

1. An illumination apparatus comprising:
a light source;
a rod-shaped light guide including, as a first surface, a light emitting surface that emits light taken from the light source; and
a light guide cover configured to cover a second surface different from the first surface among surfaces of the light guide,
wherein the second surface is a surface extending in a longitudinal direction of the light guide,
wherein the light guide cover is extended in the longitudinal direction, and
wherein the light guide cover includes at least one finger holding the light guide.

2. The illumination apparatus according to claim 1, wherein the at least one finger includes two fingers whose respective distal ends are separated from each other.

3. The illumination apparatus according to claim 2, wherein at least one of the at least two fingers is a flexible piece, and pinches the light guide by an elastic force.

4. The illumination apparatus according to claim 1, wherein the at least one finger holds an end portion of the light guide in the longitudinal direction.

5. The illumination apparatus according to claim 4, wherein the at least one finger also covers the first surface in the end portion.

6. A line sensor assembly comprising:
a housing;
an illumination apparatus according to claim 1;
a lens array configured to condense light which was emitted from the illumination apparatus and includes information of a reading target; and
a line sensor configured to photoelectrically convert the light condensed by the lens array.

7. A reading apparatus comprising a line sensor assembly according to claim 6 and an output unit configured to output read data obtained by the line sensor assembly.

8. A printing apparatus comprising a reading apparatus according to claim 7, a printing unit configured to perform printing on a medium based on a reading result of the reading apparatus, and a conveyance unit configured to convey the medium.
